(19) United States
(12) Patent Application Publication
(10) Pub. No.: US 2023/0267159 A1
(43) Pub. Date: Aug. 24, 2023

(54) INPUT-OUTPUT SEARCHING

(71) Applicant: Microsoft Technology Licensing, LLC, Redmond, WA (US)

(72) Inventor: Dany KHALIFE, Bellevue, WA (US)

(21) Appl. No.: 17/675,630

(22) Filed: Feb. 18, 2022

(51) Int. Cl. G06F 16/9538; G06F 16/951; G06F 16/954; G06F 16/901

(52) U.S. Cl. CPC G06F 16/9538; G06F 16/951; G06F 16/954; G06F 16/9027

(57) ABSTRACT

A method of improved input-output searching includes receiving a content file comprising multiple input variables, multiple functions, and multiple output variables. The output variables and the input variables include overlapping variables. The content file is converted into a tree. The tree is converted into a graph for an input-output search. The converting the tree into the graph comprises: traversing the tree to identify each function in the tree. For each identified function, the identified function is assigned as a vertex of the graph. Additionally, any input variables and output variables associated with that function are determined. Finally, the determined input variables and output variables associated with that function are assigned as vertices of the graph connected to the vertex having the assigned identified function by directional edges.

### BACKGROUND

Text searching, such as keyword searching where a user inputs in a keyword, or search term, to be searched within a document, webpage, etc., is a useful tool that is implemented by various applications. Search terms can be provided in the form of one or more textual terms. In some cases, Boolean operators (e.g., “and”, “or”, “not”) may link multiple search terms. In other scenarios, natural language processing may be available. However, search engines and associated search-based applications tend to be limited to returning results based only on the inputs provided by users. Traditional keyword(s) searches performed by search engines or search-based applications may not be precise and may not yield a proper search result.

For example, suppose that a user wishes to perform a search for a company named “cat”. If the user types in the term “cat” as a search keyword into a search engine, the search engine may provide a multitude of results which are not relevant to what the user wished to search for. For example, results returned by the search engine may include the feline animal cat instead of or in addition to results related to the company. The user may not easily narrow down the search results in order to precisely find the result the user was seeking. Users may waste time performing traditional keyword searches and have to shift through a multitude of irrelevant search results in order to find the precise result they were seeking. Other times, users may not even find what they were seeking and give up.

Traditional keyword searches are also challenging for searching certain types of content, such as semantic code, to find relevant code in a code repository. Content such as semantic code may include very large amounts of data. It may be particularly tedious for a user to search through the data in order to find what the user is seeking.

### BRIEF SUMMARY

Improved input-output searching is described.

A method of improved input-output searching can include receiving a content file including a plurality of input variables, a plurality of functions, and a plurality of output variables, wherein the plurality of output variables and the plurality of input variables include overlapping variables converting the content file into a tree (which may be an abstract syntax tree (AST); and converting the tree into a graph for the input-output search.

For converting the tree into the graph, the method can further include traversing the tree to identify each function in the tree. For each identified function, the method can include assigning the identified function as a vertex of the graph; determining any input variables and output variables associated with that function; and assigning the determined input variables and output variables associated with that function as vertices of the graph connected to the vertex having the assigned identified function by directional edges.

When a request is received for the input-output search, the request including an input variable and an output variable, the method can further include traversing the graph to find the input variable and the output variable. The method can further include parsing the graph to determine whether at least one path exists between the input variable and the output variable; and in response to determining that the at least one path exists, providing a result.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment for a search provider system used to generate a graph from an abstract syntax tree for input-output searching.

FIG. 2 illustrates an example conversion system.

FIG. 3 illustrates an example content file.

FIG. 4 illustrates an example of a tree used for improved input-output searching.

FIG. 5 illustrates an example of a graph used for improved input-output searching that is generated from a tree.

FIG. 6A illustrates an example input-output search interface.

FIG. 6B illustrates another example of an input-output search interface.

FIG. 6C illustrates another example of an input-output search interface.

FIG. 6D illustrates another example of an input-output search interface.

FIGS. 7A and 7B illustrate a method to convert a tree to a graph in order to facilitate input-output searching.

FIG. 8 illustrates a method provide a result of an input-output search.

FIG. 9 illustrates components of an example computing device that may be used in certain embodiments described herein.

### DETAILED DESCRIPTION

Improved input-output searching is described. An input-output search enables both a search of inputs and a search of outputs to be conducted. Performing a search of text and/or multimedia input-output searching may yield faster, more precise results as compared to performing a traditional keyword search that searches data based on an input. An input-output search allows a user to input multiple types of search term(s); specifically, the user may provide not only an input but also an output as search variables. An improved input-output search is possible, for example, by changing the underlying content being searched into a format specifically suitable for input-output searching. As described herein, generation of a graph by converting an abstract syntax tree (AST) for input-output searching is performed to create a graph that is in a format specifically suitable for input-output searching.

As described herein, in order to perform an input-output search, a search provider analyzes a content file. The search provider converts the content file into a tree, and then converts the tree into a graph. The graph is generated in a format that can facilitate input-output searching.

A content file contains text and/or multimedia content that include various functions and corresponding input and output variables. However, the content file does not allow for input-output searching. Therefore, the graph that is generated based on the data in the content file is provided in a format that would allow for improved input-output searching. Thus, the graph contains organized content in a format that is readily searchable in response to receipt of an input-output search. Moreover, the graph provides paths that link input variables and output variables to functions.

Traditional keyword searching techniques search data (in a file or on webpages) using one more input words called keywords. For example, suppose a data file contains a list. A user may wish to perform a keyword search to find an item in the list. The user may provide the keyword as an input and request the keyword search to determine if the keyword is contained within the list. Once a match is found between the keyword(s) and the data in the list, a result may be provided to the user requesting the search.

However, a user may wish to request a more precise search. Specifically, the user may wish to provide not just keyword(s) but rather provide input and output variables that can more specifically target what the user is searching for.

In one example, suppose that a user wishes to make a pie based on a list of ingredients the user has in stock at home. If the user used traditional keyword searching techniques to obtain pie recipes, the user may input keywords such as “pie”, “fruit pie”, or “apple pie” into a search engine. The search engine may return a multitude of search results for pies; however, the results may not be relevant to what the user is seeking. For example, the search engine may return results such as “mincemeat pie”, “pizza pie”, “shepherd's pie”, “pie bakery stores”, “frozen pies”, “3.14159 . . . ”, “rhubarb pie”, etc., whereas the user may have been seeking to make a different type of pie based on ingredients that the user has in stock.

In order to obtain a precise and specific recipe, the user may wish to perform an input-output search which allows the user to not only provide an input value but also provide an output variable as well. The user may enter various input variables such as “dough”, “apples”, and “flour” into an input-output search engine. The user may also enter an output variable such as “pie”. The input-output search engine may then find matches between the inputs and output to determine precise recipes that the user can use based on the input and output variables provided. The input-output search engine may return one or more results in the form recipes and steps to create specific pies based on the input pie ingredients provided by the user. Some results may include recipes and steps for making the following pies: apple, pineapple apple, coconut apple, cinnamon apple, savory apple, apple crumb, walnut apple, etc. In this example, the recipes and steps can be thought of as functions of the input variables ““dough”, “apples”, and “flour”) and output variable (“pie”) because in order to reach from the input variables to the output variable, the functions are to be followed.

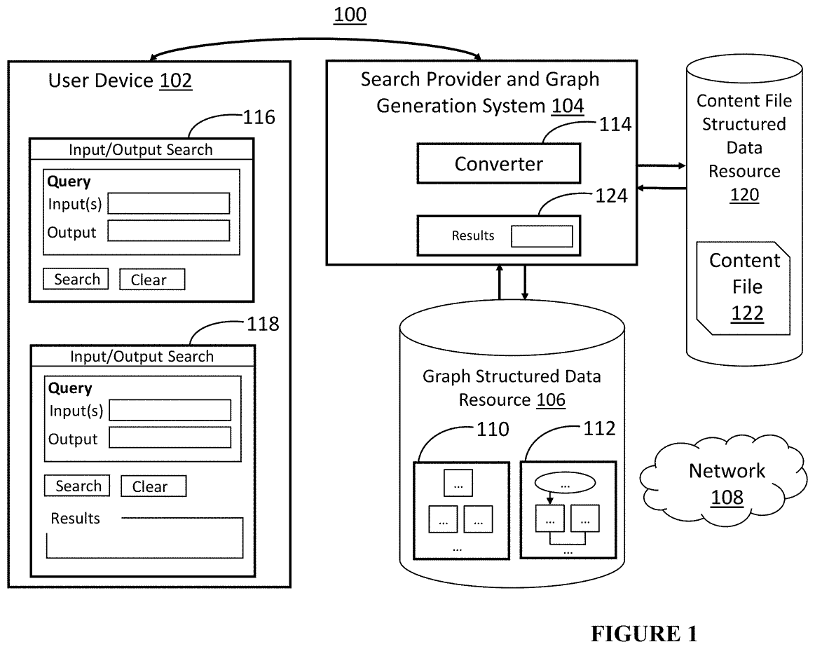

Traditional keyword searching techniques do not allow users to provide input and output variables as search criteria. In order to facilitate an input-output search, the data to be search is converted. One approach to conducting a search is to convert content to a tree (e.g., an AST) which may represent data in a logical fashion. However, ASTs may still be challenging to search, especially when performing an input-output search. Therefore, a second conversion of the AST is performed to generate a graph which more efficiently facilitates input-output searching. The graph arrangement logically depicts variables representing inputs (or input variables) and variables representing outputs (or output variables) as well as relationships between the inputs and outputs. Specifically, techniques described herein first convert content data into a tree and the data contained in the tree is then converted into a graph. Details regarding the system that converts data into the graph in order to facilitate input-output searches are described with respect to FIG. 1.

FIG. 1 illustrates an example operating environment for a search provider system used to generate a graph from an abstract syntax tree for input-output searching. As illustrated herein, an AST may be used to implement the tree used in the improved input-output searching process. However, it should be understood that other trees may be used to represent the textual content. In addition, although the first structure is referred to as a tree and the second structure is referred to as a graph, the graph may be in the form of a tree so long as the structure achieves the characteristics described herein.

Referring to FIG. 1, an input-output search environment 100 includes a user device 102, a search provider and graph generation system 104, a graph structured data resource 106, a content file structured data resource 120, and a network 108.

In order to facilitate an input-output search, data in a file is to be converted into a tree which is then converted into a graph. The tree represents the data in a logical fashion and the graph includes data converted from the tree. The graph includes data provided in a format that facilitates improved input-output searching. Input-output search environment 100 allows search provider and graph generation system 104 to perform input-output searches using the graph that organizes data in a format that allows for input-output searching. Input-output search data organized in the described graphs makes it possible to return relevant results to a user requesting an input-output search query.

Search provider and graph generation system 104 may also be referred to as “search provider” or “search provider system.” Search provider and graph generation system 104 may be implemented within a single computing device or distributed across multiple computing devices or sub-systems that cooperate in executing program instructions. Accordingly, more or fewer elements described with respect to search provider and graph generation system 104 may be incorporated to implement a particular system. Search provider and graph generation system 104 can be or otherwise include one or more blade server devices, standalone server devices, personal computers, routers, hubs, switches, bridges, firewall devices, intrusion detection devices, mainframe computers, network-attached storage devices, a reader, a mobile device, a personal digital assistant, a wearable computer, a smart phone, a tablet, a laptop computer, a gaming device or console, an entertainment device, a hybrid computer, a desktop computer, a smart television, appliance, and other types of computing devices.

In embodiments where search provider and graph generation system 104 includes multiple computing devices, search provider and graph generation system 104 can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

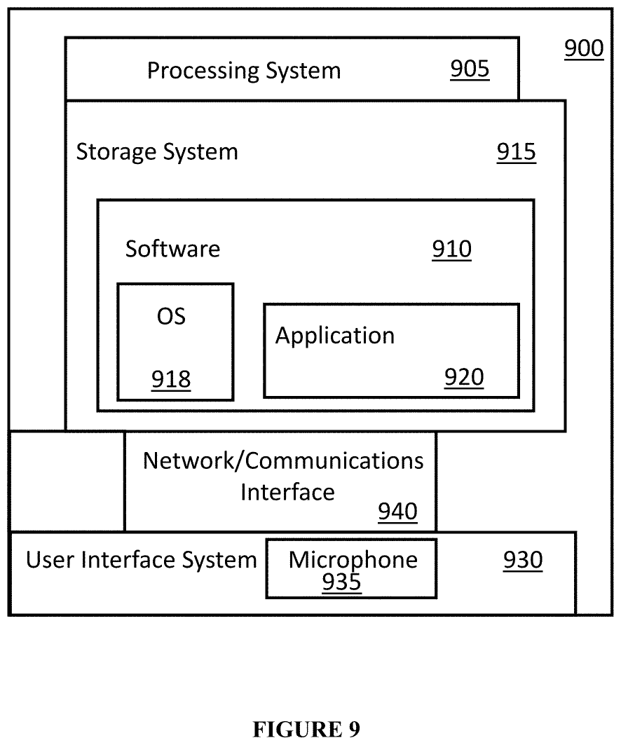

Search provider and graph generation system 104 includes a processing system of one or more hardware processors and a storage system (for example, as depicted in FIG. 9). Examples of processors of the processing system include general purpose central processing units (CPUs), graphics processing units (GPUs), field programmable gate arrays (FPGAs), application specific processors, and logic devices, as well as any other type of processing device, combinations, or variations thereof.

Raw (uncompiled) data may be contained in a content file 122 stored in content file structured data resource 120 or elsewhere. Content file 122 is depicted as being stored in the content file structured data resource 120 and external to search provider and graph generation system 104 and graph structured data resource 106. However, in other embodiments, content file 122 may be stored within the graph structured data resource 106 or elsewhere and be accessible by search provider and graph generation system 104. In some examples, the content file 122 may contain textual and/or multimedia data such as source code, web page content, article, videos, audio data, computer code, etc. Content file 122 may include data that can be used to perform a specific task. For example, content file 122 may be computer code which can be programmed to create an application.

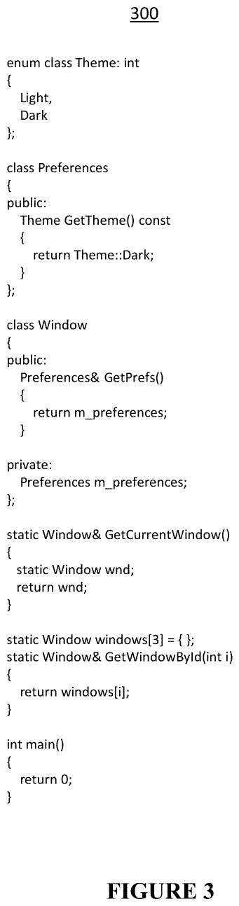

Content file 122 may include raw data not organized in a manner that would best facilitate input-output searching. In an embodiment, if content file 122 contains computer code, the code contained therein may be uncompiled code. Content file 122 may include multiple input variables, multiple functions, and multiple output variables. The multiple output and input variables may include overlapping variables. An example content file is depicted in FIG. 3 and described herein below.

Search provider and graph generation system 104 may receive the contents of content file 122. The content file 122 includes multiple input variables, multiple functions, and multiple output variables. The output and input variables include overlapping variables (described herein below). As described above, in order to perform input-output searching of content contained within the content file 122, data contained within the content file 122 is converted into formats more suitable for input-output searching. Specifically, the underlying content that is to ultimately be searched in the content file 122 is converted into a tree that logically represents the content. The tree is then converted into a graph, where the graph logically arranges input variables, output variables and functions in a format that depicts relationships (paths) between the variables and functions. Once the relationship between input and output variables is created and depicted in the graph, an input-output search can be performed on the graph to yield paths between the input variables and output variables (and intervening functions in the paths can be provided as results to input-output searching). Search provider and graph generation system 104 may convert (e.g., compile) content file 122 via a converter 114. Converter 114 may be a compiler that is capable of compiling the data contained in the content file 122. In one embodiment, an analyzer (not depicted) may search the contents of the content file 122 and feed it to the converter 114.

Converter 114 first converts the content file 122 into a tree 110 to convert the contents of the content file 122 into a logical representation. Converter 114 then converts the tree 110 into a graph 112. Graph 112 organizes data in a format that can facilitate input-output searching as the graph 112 logically relates input and output functions and functions. For example, the graph 112 contains vertices and edges, where the vertices represent input variables, output variables, overlapping variables and functions. Paths between vertices depict relationships between variables. For example, a path between at least two of an input variable, a function, or an output variable represents an atomic operation. In an embodiment, a path contains at least a function and a variable.

Converter 114 may traverse the tree 110 to identify each function in the tree 110. For each identified function the converter 114 may assign the identified function as a vertex of the graph. The converter 114 may determine any input variables and output variables associated with that function and assign the determined input variables and output variables associated with that function as vertices of the graph connected to the vertex having the assigned identified function by directional edges.

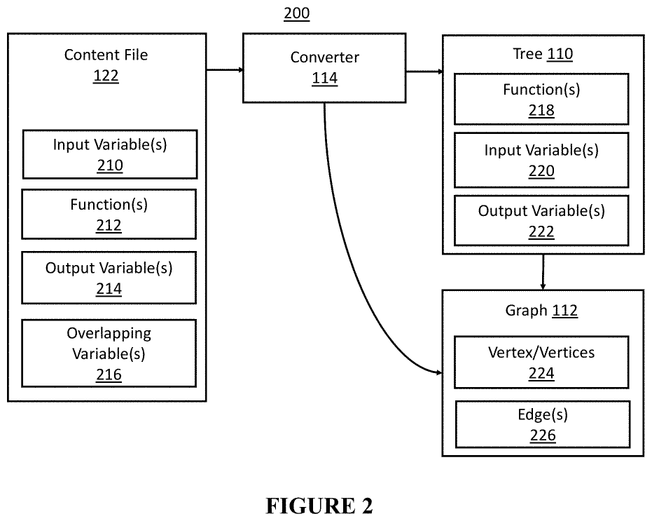

When an input-output search request is made to find a match between a vertex that represents an input variable and a vertex that represents an output variable, the graph 112 can facilitate the search. Details regarding the conversion of the tree and the graph are described herein below with respect to FIGS. 2-5.

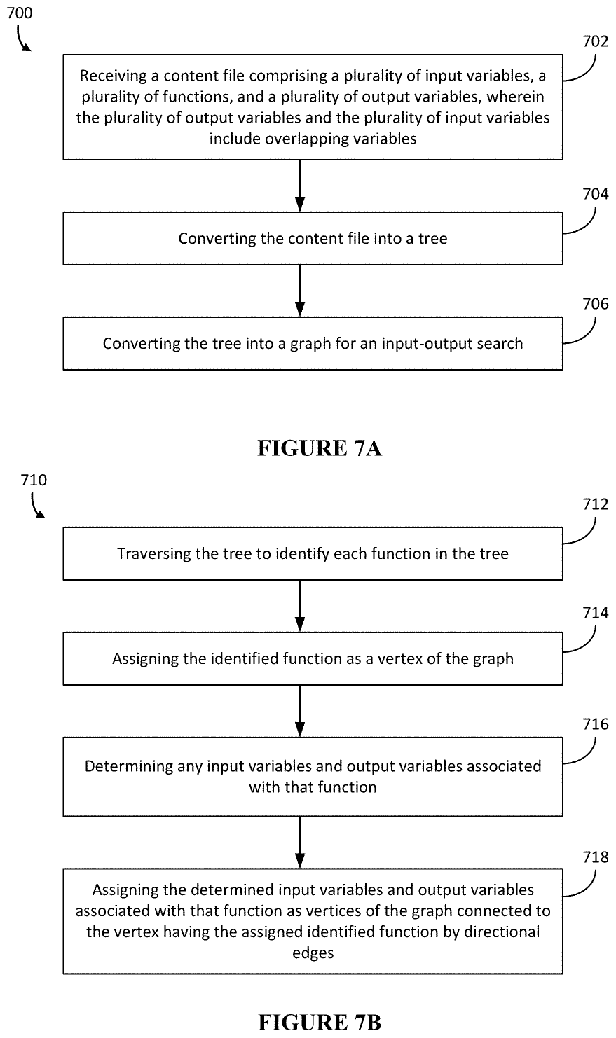

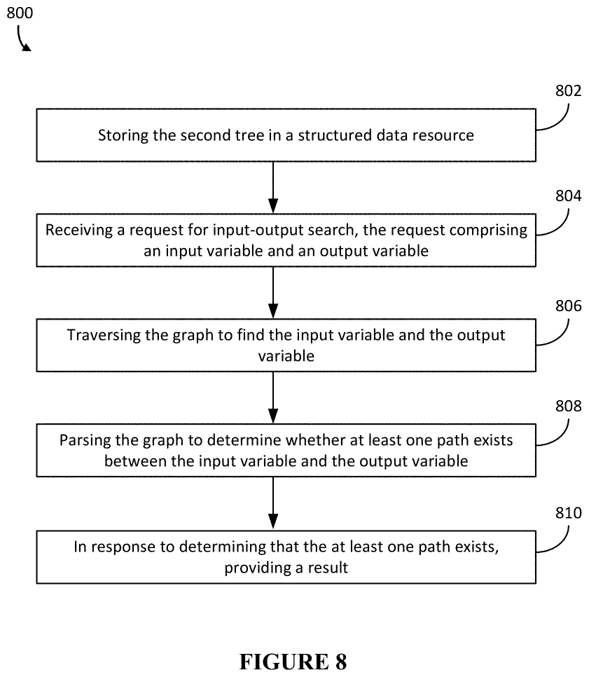

The tree 110 and the graph 112 may be stored in the graph structured data resource 106. In other embodiments (not depicted), the tree 110 and the graph 112 may be stored elsewhere or in multiple structured data resources accessible by the search provider and graph generation system 104. The graph 112 is created in a format that is suitable for input-output searching. The graph structured data resource 106 may comprise any computer readable storage media readable by the processing system and capable of storing software executable by processor(s) of the processing system with instructions for performing method 700 and processes 800 as described with respect to FIG. 7A, and FIGS. 7B, and 8, respectively.

Graph structured data resource 106 may include volatile and nonvolatile memories, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, magnetic cassettes, magnetic tape, magnetic disk storage or other magnetic storage devices, or any other suitable storage media. In no case does “storage media” or “computer-readable storage medium” consist of transitory, propagating signals.

Graph structured data resource 106 may be implemented as a single storage device but may also be implemented across multiple storage devices or sub-systems co-located or distributed relative to each other. Graph structured data resource 106 may include additional elements, such as a controller, capable of communicating with processing system. Graph structured data resource 106 can include one or more databases.

A user may operate user device 102 to provide an input-output search query or request. In an embodiment, the user device 102 may include one or more computing devices such as personal computers (PCs), laptops, mobile phones, smart phones, tablet computers, netbook computers etc. User device 102 may include a display (not depicted) that allow users to view images, videos, web pages, documents, etc.

A user employing user device 102 may provide an input-output search request via a user a user interface 116. Specifically, the user interface 116 may be provided by the search provider and graph generation system 104 to the user device 102 for display on a display device (not depicted) in a format suitable for display by a graphical user interface of user device 102. User interface 116 allows the user to provide text into the “input(s)” and/or “output” search textbox window. User interface 116 may also include other icon or buttons such as a “search” or “clear”. Once the user types in the appropriate text for the input and output variables in the corresponding textbox windows and selects the “search” button, the request is sent to the search provider and graph generation system 104.

Converter 114 of the search provider and graph generation system 104 may then convert content file 122 into the tree 110 and then convert the tree 110 into the graph 112 and store the tree 110 and/or the graph 112 in graph structured data resource 106. In other embodiments, the tree 110 and the graph 112 may have already been converted by converter 114 and stored in graph structured data resource 106. Search provider and graph generation system 104 may perform the search requested by the user by parsing the graph 112 in order to yield a result. A result may indicate that a match is found for the input-output search request; that is, a path exists between the input variable and the output variable in the graph 112. In other embodiments, a result may indicate that no match is found. The generation of tree(s) and graph(s) and performing of searches may be conducted separately of one another. Although a single search provider and graph generation system 104 is depicted, multiple systems may be used.

Search provider and graph generation system 104 may provide results in a form capable of being displayed as an interface 124 to user device 102. User device 102 may then output the results in a “results” textbox window in a user interface 118 in a format that can be viewed by the user. Specifically, user interface 118 may be provided by the search provider to user device 102 for display on a display device (not depicted) in a format suitable for display by a graphical user interface of user device 102.

Components depicted in FIG. 1 (the user device 102, the search provider and graph generation system 104, the graph structured data resource 106, the content file structured data resource 120) in the input-output search environment 100 may operate on or in communication with each other over network 108. Network 108 can be, but is not limited to, a cellular network (e.g., wireless phone), a point-to-point dial up connection, a satellite network, the Internet, a local area network (LAN), a wide area network (WAN), a Wi-Fi network, an ad hoc network or a combination thereof. Such networks are widely used to connect various types of network elements, such as hubs, bridges, routers, switches, servers, and gateways. Network 108 may include one or more connected networks (e.g., a multi-network environment) including public networks, such as the Internet, and/or private networks such as a secure enterprise private network. Access to network 108 may be provided via one or more wired or wireless access networks as will be understood by those skilled in the art.

As will also be appreciated by those skilled in the art, communication networks can take several different forms and can use several different communication protocols. Certain embodiments of the invention can be practiced in distributed-computing environments where tasks are performed by remote-processing devices that are linked through a network. In a distributed-computing environment, program modules can be located in both local and remote computer-readable storage media.

Communication to and from the components may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

FIG. 2 illustrates an example conversion system. FIG. 2 depicts graph conversion environment 200 that includes the content file 122, the converter 114, the tree 110, and the graph 112. Although the content file 122, the converter 114, the tree 110, and the graph 112 are depicted in FIG. 1, in other embodiments, any of these components may be different than the corresponding ones depicted in FIG. 1.

The contents of the content file 122 includes input variable(s) 210, function(s) 212, output variable(s) 214, and overlapping variable(s) 216. Reference to FIG. 3, which illustrates an example content file, is made herein. FIG. 3 depicts a content file 300 which includes source code. Although content file 300 is depicted as including textual source code, in other embodiments, content file 300 may be in any format or multiple formats. The content file 300 in FIG. 3 may be an example of the content file 122 in FIG. 1 and FIG. 2.

The content file 300 in FIG. 3 depicts a class called “Theme”. The content file 300 includes various functions such as “GetCurrentWindow”, “GetWindowByID”, “Window::GetPrefs” (inside the class “Window”), “main”, and “Preferences::GetTheme” (inside the class “Preferences”).

Each function may include respective input and/or output variables. For example, the function “GetWindowByID” has an input variable “int” and returns an output variable “Window”. The function “GetPrefs” returns an output variable “Preferences” and can have an input variable “Window”. The function “GetTheme” which is a public function has an input variable “Preferences” and returns an output variable “Theme”. The function “GetCurrentWindow” returns an output variable “Window”. Finally, the function “main” returns an output variable “int”.

Input and output variables may include overlapping variables. For example, an input or output variable may also be an object of both types of variables. For example, the variable “Window” is an overlapping variable as it can be an input variable as well as an output variable.

Referring again to FIG. 2, when the converter 114 receives the content file 122, the converter 114 analyzes the content file 122 and converts the content file 122 to a tree and then converts the tree into a graph. In one example, the converter 114 may be a compiler which compiles the content file 122. In addition to compiling the content file 122, the converter 114 converts the content file 122 into the tree 110. In another embodiment, the compiling performed by the converter 114 may include the conversion.

The tree 110 includes function(s) 218, input variable(s) 220, and output variable(s) 222. In an embodiment, the input variable(s) 210 in content file 122 are the same as the input variable(s) 220 in the tree 110; the output variable(s) 214 in the content file 122 are the same as the output variable(s) 222; and the function(s) 212 in the content file 122 are the same as the function(s) 218 in the tree 110. Moreover, some of the input variable(s) 220 and/or some of the output variable(s) 222 in the tree 110 may be the same as the overlapping variable(s) 216.

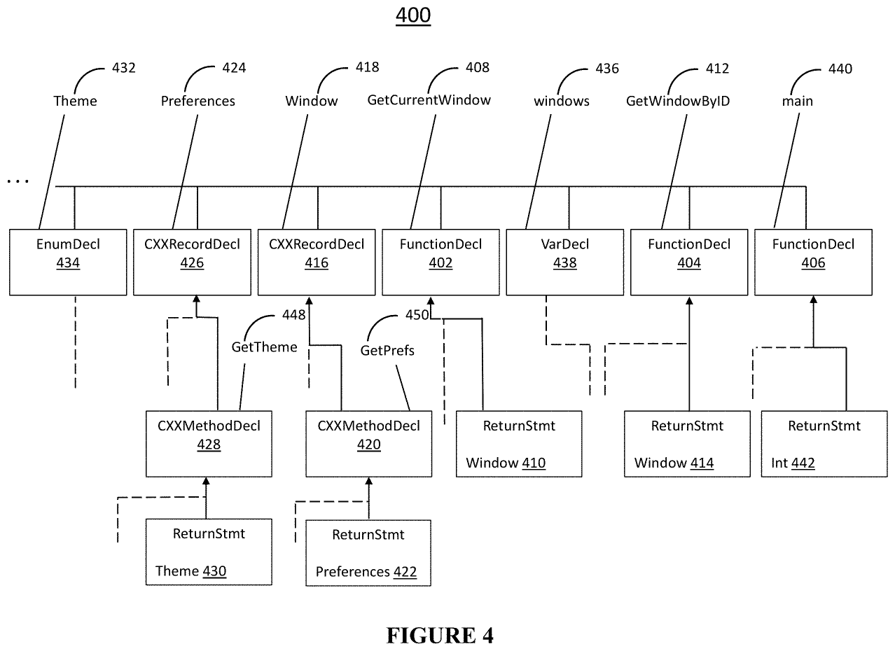

FIG. 4 depicts an example of a tree used for improved input-output searching. Tree 400 may depict a tree-structured implementation of the content file 122 as converted by converter 114. The tree 400 in FIG. 4 may be substantially similar to or the same as the tree 110 in FIG. 1 and FIG. 2. In an embodiment, additional or fewer functions and variables than depicted may be included. An indexer (not depicted) may filter out portions of tree 400 that is relevant to input-output searching to optimize tree 400 to provide useful information and filter out any information not used. Otherwise, the converter 114 may perform the filtering.

The tree 400 includes functions, input and output variables. The converter 114 may convert the content file 122 into the tree 400 using any technique. The tree 400 includes nodes and edges. In one embodiment, the converter 114 may traverse the tree 400 in order to identify functions. For example, the converter 114 may identify the following function declarations: “FunctionDecl” 402, “FunctionDecl” 404, “FunctionDecl” 406 which are nodes as depicted in tree 400. “FunctionDecl” 402 is the function “GetCurrentWindow” 408; “FunctionDecl” 404 is the function “GetWindowByID” 412; and “FunctionDecl” 406 is the “main” 440 function.

Each function declaration returns a return statement “ReturnStmt”. “FunctionDecl” 402 returns “ReturnStmt” with the variable of type “Window” 410. “FunctionDecl” 404 returns “ReturnStmt” with the variable of type “Window” 414. “FunctionDecl” 406 returns “ReturnStmt” with the variable of type “Int” 442.

“CXXRecordDecl” 416 has the type “Window” 418. “CXXRecordDecl” 426 has the object type “Preferences” 424. “EnumDecl” 434 has the object type “Theme” 432. “VarDec” 438 is has the object type “windows” 436.

“CXXMethodDecl” 428 has is the function “GetTheme” 448 (corresponding to “Preferences::GetTheme” of FIG. 3). “CXXMethodDecl” 420 is the function “GetPrefs” 450 (corresponding to “Window::GetPrefs” of FIG. 3). Each of the “CXXMethodDecl” return a corresponding return statement “ReturnStmt”. “CXXMethodDecl” 428 returns “ReturnStmt” with the variable of type “Theme” 430. “CXXMethodDecl” 420 returns “ReturnStmt” with the variable of type “Preferences” 422.

“Window”, “Preferences”, and “Theme” are overlapping variables as they can be any object type (a variable that can be an input variable and/or an output variable). In an embodiment, several additional elements may be included in the tree 400 that are not depicted in FIG. 4. Such elements may be portions of the tree 400 that are filtered out by the search provider and graph generation system 104.

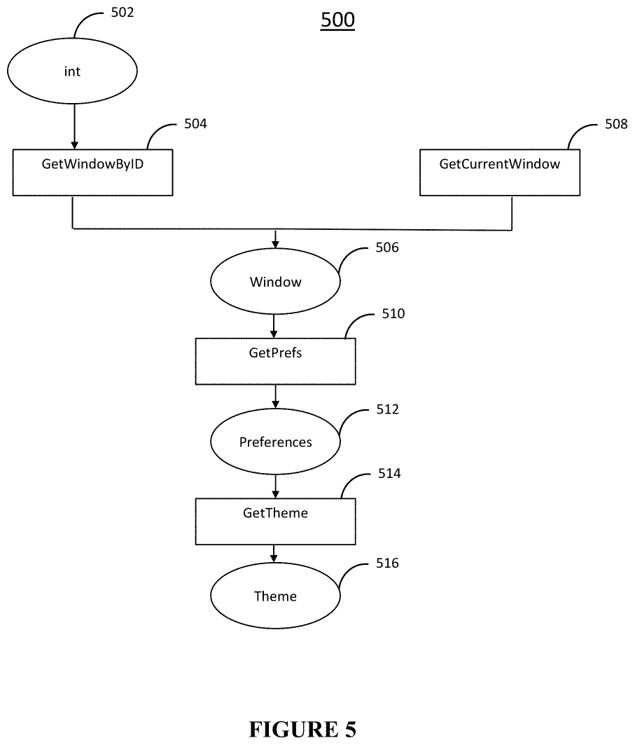

In an embodiment, the tree 400 may be substantially similar to or the same as an AST. The tree 400 in FIG. 4 may be substantially similar to or the same as the tree 110 in FIG. 1 and FIG. 2. The graph 500 in FIG. 5 may be substantially similar to or the same as the graph 112 in FIG. 1 and FIG. 2.

The tree 400 provides a tree-structure. In order to perform an input-output search, the tree 400 is converted into a graph 500, as depicted in FIG. 5.

Referring back to FIG. 2, the converter 114 converts the tree 110 into the graph 112. The graph 112 includes vertex/vertice(s) 224 and edge(s) 226. FIG. 5 illustrates an example of a graph used for improved input-output searching that is generated from a tree. In an embodiment, additional or fewer functions and variables than depicted may be included. An indexer (not depicted) may filter out portions of the tree 400 before converting it to the graph 500 to optimize tree 400 (prior to the conversion) to provide useful information and filter out any information not used. The unfiltered or remaining portions are relevant to input-output searching

The graph 500 in FIG. 5 is generated by the converter 114. In order for the converter 114 to convert the tree 400 into the graph 500 to facilitate input-output searching, the converter 114 traverses the tree 400 to identify each function in the tree. For example, the converter 114 may identify all function declarations (“FunctionDecl” 402, “FunctionDecl” 404, “FunctionDecl” 406) in the tree 400. The converter 114 may also identify the other functions.

For each of the identified functions, the converter 114 assigns the identified function as a vertex of the graph 500 and determines any input variables and output variables associated with that function. The converter 114 also assigns the determined input variables and output variables associated with that function as vertices of graph 500 connected to the vertex having the assigned identified function by directional edges that include directional arrows.

As depicted in FIG. 5, a vertex “int”, which is the output variable of the function “main” in FIGS. 3 and 4, is the initial vertex “int” 502 at the top of FIG. 5. The converter 114 traverses the tree 400 to identify the “FunctionDecl” 402 having the function “GetCurrentWindow” 408. In one embodiment, the function declarations are not attached to any objects, and therefore, the converter 114 may start traversing the tree 400 by identifying the functions of the function declarations. In other embodiments, the converter 114 may use any method to traverse the tree 400.

Next, the converter 114 assigns the identified function (“GetCurrentWindow” 408) as a vertex of the graph 500 as the vertex “GetCurrentWindow” 508. As depicted, the function “GetCurrentWindow” is assigned as a rectangular vertex (indicative of it being a function).

After that, the converter 114 determines if there are any input variables and output variables associated with that function. The function “GetCurrentWindow” has only an output variable “Window” associated therewith. The converter 114 assigns that output variable as another vertex of the graph 500. Specifically, “Window” 506 is the vertex that is associated with the vertex “GetCurrentWindow” 508. The directional arrow connecting the two vertices (also referred to as an edge) indicates that vertex “Window” 506 is an output of the vertex “GetCurrentWindow” 508. As depicted, output variable “Window” is assigned as an oval vertex (indicative of it being an object type that is an input or an output variable).

Additionally, the converter 114 assigns the function “GetWindowByID” in the tree 400 as the vertex “GetWindowByID” 504 in the graph 500. The arrow connecting the vertex “GetCurrentWindow” 508 to the vertex “Window” 506 (which is an output of the vertex “GetCurrentWindow” 508) is directional, as it points down from the function to the output. The converter 114 also traverses the tree 110 to determine that the function “GetWindowByID” has input variable “int” and assigns “int” as vertex “int” 502.

The converter 114 may then traverse the tree 110 to assign a vertex to the function “GetPrefs” or the converter 114 may determine if the vertex “Window” 506 is an overlapping variable and find the corresponding function. The converter 114 determines that vertex “Window” 506 is the input of a function “GetPrefs” and assigns a vertex “GetPrefs” 510. The directional arrow between the vertex “Window” 506 and the vertex “GetPrefs” 510 is pointing downwards, therefore, indicative of the vertex “Window” 506 being an input of the vertex “GetPrefs” 510.

The converter 114 may then determine that the output variable “Preferences” is the output of the function “GetPrefs” and assigns a vertex “Preferences” 512. The directional arrow between the vertex “GetPrefs” 510 and the vertex “Preferences” 512 is pointing downwards, therefore, indicative of the vertex “Preferences” 512 being an output of the vertex “GetPrefs” 510.

The converter 114 may then traverse the tree 110 to assign a vertex to the function “GetTheme” or the converter 114 may determine if “Theme” is a variable (an output variable in this case) and find the corresponding function. The directional arrow between the vertex “GetTheme” 514 and the vertex “Theme” 516 is pointing downwards, therefore, indicative of the vertex “Theme” 516 being an output of the vertex “GetTheme” 514.

If additional functions or variables remain, the converter 114 maps them accordingly onto the graph 500. Referring again to FIG. 2, the converter 114 maps a vertex/vertice(s) 224 and edge(s) 226 on the graph 112 based on the function(s) 218, the input variable(s) 220, and the output variable(s) 222 provided by the tree 110.

The search provider may recursively search vertices to find additional paths until no path remains. Any number of various techniques may be used in order to recursively perform the search. In one embodiment, the search provider may recursively determine additional variables and functions associated with another function or variables in the graph. The search provider may then append the graph to include the additional functions or variables. The search provider may recursively perform these steps until the graph is complete. In one embodiment, the search provider may use expansion to recursively perform the search. For example, suppose that the following functions are provided: Functions: A, B and the following variables are provided: Variables X, Y, Z, T. The graph generated may depict the following paths depicting an input variable(s), a function, and an output variable, each separated by an arrow: X→A→Y; and (X and Y are both provided as inputs)→B→T. If a search is performed where the input variable is “X” and the output variable is “Y”, the results would be based on the following. The search provider would go to X and perform function A in order to obtain Y. The search provider would go the same X and pass it alongside Y to function B and obtain T. Thus, an expansion of X is performed.

Although the converter 114 of search provider and graph generation system 104 is depicted as converting the content file 122 into a tree and a graph, more or fewer trees and graphs than depicted may be used to generate a final graph that can facilitate input-output searching. Additionally, a pre-compiler, analyzer, or other computer program may search the content file 122 prior to providing it to the converter 114.

Although the tree and the graph are depicted as having nodes and edges and vertices and edges, respectively, in other embodiments, trees and/or graphs may be represented as text files, multimedia files, or a combination thereof. The tree and graph depicted provide a logical representation of the content file. In the graph, a pair of vertices and associated edges between the pair of vertices (depicting a path) represent an individual atomic operation. For example, a path may represent an atomic operation in between at least two of a vertex containing an input variable, a vertex containing a function, or a vertex containing an output variable. For example, at least one input variable and a function, at least one output variable and a function, or both an input variable and an output variable and a function may be represented by the atomic operation.

Although the trees and graphs are depicted as example tree-structures and graph-structures, respectively, providing a logical representation of the content file, in other embodiments, the trees and graphs may be visually represented in any graphical, textual, or multimedia format.

Suppose that the content file 122 is a webpage that contains multiple recipes. Each recipe may include an ingredients section along with steps for creating the recipe. The search provider and graph generation system 104 may parse the webpage to extract ingredients from the ingredients section. The search provider and graph generation system 104 may then eventually map each of the ingredients to vertices to the graph 112. The search provider and graph generation system 104 may first generate the tree 110 as described herein prior to the generation of the graph 112. The search provider and graph generation system 104 may review each step of the recipe to determine input variables and output variables. Each of the steps have an “input variable(s)” which are the ingredient(s)) as well as an “output variable” which is the output generated from previous recipe steps. Thus, when generating the graph 112, each output variable of a recipe is mapped to a vertex by the search provider and graph generation system 104.

For example, suppose there is a recipe for roasted potatoes. A first recipe step may state: “Step 1: wash potatoes”; a second recipe step may state: “Step 2: peel potatoes”; a third recipe step may state: “Step 3: dice potatoes”; and so forth. The search provider and graph generation system 104 may generate the graph 112 and map the following as vertices: potatoes (1), washed potatoes (2), peeled potatoes (3), diced potatoes (4), etc. The functions of the graph 112 would be as follows: wash potatoes (A), peel potatoes (B), dice potatoes (C), etc. The graph 112 would provide the following: (1)->(A)->(2)->(B)->(3)->(C)->(4).

### Example of Input-Output Search of Graph

Suppose now that a user wishes to perform an input-output search and sends a query to a search provider. The user may provide an input variable “int” and an output variable “Theme” in the search query that sent to the search provider to determine if a match exists between the input variable and the output variable. The user may initiate the search using a user device and the user device may transmit the search to the search provider. The search provider may then return as a result the vertices that exist between the vertex “int” 502 and the vertex “Theme” 516 in the graph 500. Additionally, if multiple steps can be taken to return the results traversing from an input variable to an output variable, the search provider provide the multiple steps or may apply Dijkstra's algorithm in order to determine a shortest path (or smallest number of hops) between two vertices. Thus, if the search provider determines that multiple paths exist between the input variable and the output variable, the search provider may determine a shortest path of the multiple paths. The graph may have metrics associated with each operation (the function to be performed). An example of a metric may be the following: “the time it needs to execute”; another example may be: “memory consumption”. The search provider can determine a shortest path as one that minimizes or maximizes a certain metric. A base metric may be provided as follows:—metric name=number of hops;—every operation has a “cost” of 1;—the search provider optimizes for the “Min” of the metric. The Min translates into the minimum number of operations.

In one embodiment, when the search provider performs the input-output search, the search may be performed by searching for path(s) from the bottom of the graph towards the top. In another embodiment, the search provider may perform the search for path(s) from the top of the graph towards the bottom. In yet other embodiments, a search may be performed for path(s) from the bottom towards the top at the same time as another search is performed from the top towards the bottom of the graph to determine which method is faster (or which method encounters the fewest hops).

In yet another embodiment, the search provider may perform an input-output search that yields no results. In such an embodiment, when the search provider determines that no matches exist for the input-output search, the search provider determines that no paths exist and may send a notification to the user. The notification may indicate that no matches are found, or no path between the input and the output variables exists.

In some embodiments, the user may provide only an input or only an output variable to the search provider to perform the search. In other embodiments, the user may provide multiple inputs and/or outputs variables to the search provider. In other embodiments, the user may provide a portion of a path along with or instead of providing the input and/or output variables.

In an embodiment, prior to receiving a request from a user to perform an input-output search, the search provider may store the graph in a structured data resource such as a storage device that includes a database. When the search provider receives the request for the input-output search, where the request includes an input variable and an output variable, the search provider traverses the graph to find the input variable and the output variable. The search provider then parses the graph to determine whether at least one path exists between the input variable and the output variable. In response to determining that the at least one path exists, the search provider provides the result to the user device for display to the user.

### Source Code Example

In an embodiment, a user can perform an input-output search on software source code. In this embodiment, the search provider converts the code into a tree and then a graph which allows for robust input-output searching. Software source code can be lengthy, and it may be difficult to find source code based on input and/or output variables. By performing traditional keyword searching, a user may not be able to precisely and/or timely find code that the user is seeking. If a user is unable to locate the code that he is seeking using keyword searching, the user may end up rewriting code redundantly.

Therefore, performing an input-output search on source code allows a user to precisely find the information requested.

### Search Engine Example

In another embodiment, suppose that a user wishes to perform an input-output search using a search engine. The search engine may obtain content using web crawlers to constantly download and index content found over the Internet. The indexing may be performed by functional, data-flow language called Gremlin Query Language. The indexed content may then be stored as one or more content files. The converter may then generate a tree and then a graph from the search engine content file. Alternatively, the Gremlin Query Language may create the tree and the converter of the search provider can convert the tree into the graph.

The graph can be used by the search engine to provide results of an input-output search where a user provides one or more input and/or output variables in a search query. The search engine may utilize the results to optimize future input-output search results in view of the one or more input and/or output variables used to perform the search.

### Additional Examples of Input-Output Searches

In one example, suppose that a user such as an astrophysicist wishes to seek a planet that has Earth-like properties. Keyword searching may not provide the astrophysicist with the precise result sought. The astrophysicist may be aware of a function (i.e., formula) that would allow calculation of the amount of oxygen in the atmosphere of a planet based on the volume of water on the planet and the temperature of the planet's core. The temperature of the core of the planet may be calculated using another function that uses the volume of the planet and atmospheric pressure. If the astrophysicist had knowledge of a volume of a planet and atmospheric pressure, the astrophysicist can provide these as input variables to a search provider capable of performing input-output searching and request the search provider return functions that would provide the temperature of the planet's core (which can be provided as an output of the search).

Additionally, if the astrophysicist provided both the volume of the planet and the volume of water present on the surface, and the atmospheric pressure, the astrophysicist can send a request to the search provider to perform an input-output search and find ways to calculate the amount of oxygen in the atmosphere given the information the astrophysicist possesses. The search provider would provide perform the input-output search and provide both functions to the astrophysicist in one result (e.g., in one user interface). Example representations of user interfaces that provide results are described below.

### User Interfaces

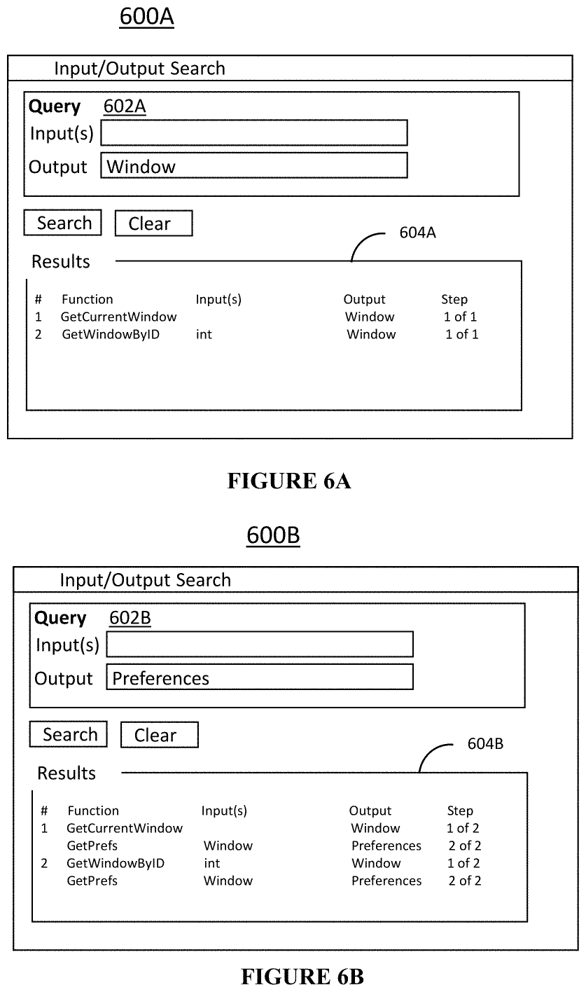

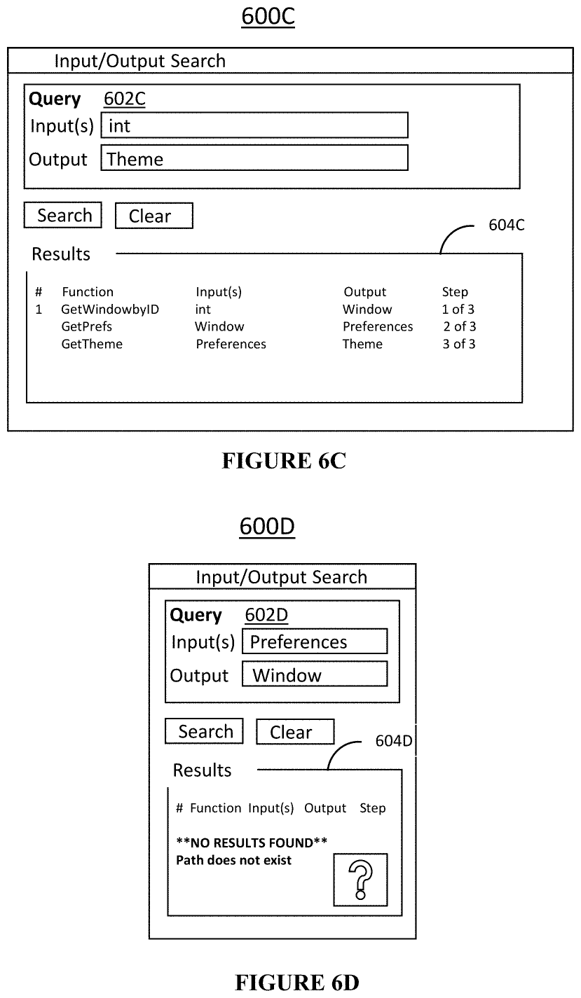

FIG. 6A illustrates an example input-output search interface. Input-output search interface 600A depicts a query box 602A where a user employing a user device can provide input(s) and/or output variables. After the user selects the search button, the search provider performs an input-output search (as described above with respect to FIG. 1). The search provider generates the results window 604A.

As described above, the tree and the graph have been converted based on the content file.

The results window may include a “#” column indicative of a number of results; an “Input(s)” column indicative of input(s) variables; an “Output” column indicative of an output variable; and a “Step” column indicative of steps taken to get from the input variable to the output variable in the graph. In an embodiment, the search provider may interpret the output column as multiple outputs, where the search provider would search for independent paths from a subset of inputs to all of the outputs separate from one another.

Input-output search interface 600A lists an empty or null value for the input(s) (also referred to as the input(s) variable(s)) and “Window” as the output (also referred to as the output variable). Either of the input(s) or output fields may be left blank which will be interpreted as empty by the search provider. The empty value is further interpreted by the search provider as “any” (input and/or output) variable. Upon selecting the “search” button, input-output search interface 600A provides for display results that are found or a notification that no results are found based on the input-output search performed by the search provider.

Input-output search interface 600A lists the output “Window”. The search provider, after receiving the output variable “Window” (upon the user selecting the “search button”) performs an input-output search of graph 500 to find search results for all output “Window” variables. The search provider may parse the graph 500 using any method, including the top to bottom and/or bottom to top approaches described above.

For the output variable “Window”, the search provider yields two results (#1, and #2). Row #1 indicates that for the output variable “Window”, the function is “GetCurrentWindow”. Referring now to FIG. 5, the search provider may find vertex “Window” 506 and determine that for any input, the first function that has “Window” as an output variable is represented by the vertex “GetWindowByID” 504 and the second function is represented by the vertex “GetCurrentWindow” 508. The second function represented by the vertex “GetCurrentWindow” 508 has a corresponding input variable “int” as represented by the vertex “int” 502.

Therefore, the search provider returns the results window 604A that provides two results that have the output variable “Window”. For each of the results, the corresponding number (#), function, input(s) and steps are provided.

In the depicted embodiment, as only one step (or hop) is required for the path to get to the vertex “Window” in the graph for both numbers 1 and 2, the “Step” column lists “1 of 1” for both search results.

FIG. 6B illustrates another example of an input-output search interface. Input-output search interface 600B, having a query box 602B, lists an empty or null value for the input(s) variable and “Preferences” as the output variable. The search provider, after receiving the output “Preferences” (upon the user selecting the “search button”) performs an input-output search of graph 500 to find search results for all output “Preferences” variables. The search provider may parse the graph 500 using any method, including the top to bottom and/or bottom to top approaches described above. For the output variable “Preferences”, the search provider yields two results (#1, and #2). Row #1 indicates that for the output variable “Preferences”, there are two steps that are taken (step 1 of 2 and step 2 of 2, as indicated in the “Step” column). For step 2 of 2, when the output variable is “Preferences”, the function is “GetPrefs” and the input variable is “Window”. For step 1 of 2, for the output variable “Window” (which was the input variable in step 2 of 2, and is thus an overlapping variable), the function is “GetCurrentWindow” and there is no input variable.

Referring now to FIG. 5, the search provider may find the vertex “Preferences” 512 and determine that for that variable, the corresponding function is vertex “GetPrefs” 510. Vertex “GetPrefs” 510 has an input variable vertex “Window” 506. However, vertex “Window” 506 has additional paths and therefore, the search provider may return an additional step indicative of the vertex “Window” 506 (which is an output variable to function “GetCurrentWindow”). The corresponding function is the vertex “GetCurrentWindow” 508 and that function does not have an input variable. Therefore, the search provider updates search provider returns results window 604B to list the function in the “Function” column as “GetCurrentWindow”, the “Output” column as “Window” and the “Input(s)” column as empty or null.

Additionally, the search provider determines that the output variable “Preferences” also has a different path that returns from a null or any value to “Preferences” as indicated in #2 of results window 604B. In step 2 of 2 for #2, the column is the same as step 2 of 2 for #1. However, for step 1 of 2, it is determined that a different function “GetWindowByID” has the output variable “Window” and an input variable “int”. Search provider parses graph 500 to generate the table and returns the results window 604B.

Thus, the search provider returns the results window 604B that provide two results that have the final output variable “Preferences” (where each of the results have two corresponding steps). For each of the results, the corresponding number (#), function, input(s) variable, output variable, and steps are provided.

FIG. 6C illustrates another example of an input-output search interface. Input-output search interface 600C, having a query box 602C, lists “int” as the input(s) variable and “Theme” as the output variable. The search provider, after receiving the input variable “int” and the output variable “Theme” (upon the user selecting the “search button”) performs an input-output search of graph 500 to find search results for an input variable “int” that has an output variable “Theme”. The search provider may parse graph 500 using any method, including the top to bottom and/or bottom to top approaches described above. For the input variable “int” and the output variable “Theme”, the search provider yields one result (#1). Row #1 indicates that there are three steps that are taken (step 1 of 3, step 2 of 3, and step 3 of 3, as indicated in the “Step” column). For step 3 of 3, when the output variable is “Theme”, the function is “GetTheme” and the input variable is “Preferences”. For step 2 of 3, for the output variable “Preferences” (which was the input variable in step 3 of 3, and is thus an overlapping variable), the function is “GetPrefs” and the input variable is “Window”. For step 1 of 3, for the output variable “Window” (which was the input variable in step 2 of 3, and is thus an overlapping variable), the function is “GetWindowbyID” and the input variable is “int”.

Referring now to FIG. 5, the search provider may find the vertex “Theme” 516 and determine that for that variable, the corresponding function is vertex “GetTheme” 514. Vertex “GetTheme” 514 has an input variable vertex “Preferences” 512. Vertex “Preferences” 512 is an output variable to function “GetPrefs”, as indicated by the directional arrow connected to the vertex “GetPrefs” 510. Vertex “GetPrefs” 510 has an input variable vertex “Window” 506. Vertex “Window” 506 is the output variable to two corresponding functions; one represented by the vertex “GetCurrentWindow” 508 which has no input variable and the vertex “GetWindowByID” 504 which has the input variable represented by the vertex “int” 502.

Search provider parses graph 500 to generate the table and returns results window 604C. Thus, the search provider returns results window 604C that provide one result that has an initial input variable “int” and the final output variable “Theme” and the result, to go from the input variable to the output variable, has three steps.

The edges connecting vertices are directional. Therefore, the search provider may use the directional arrows in order to determine relationships between vertices representing input and output variables and functions. If, for example, a directional arrow originating at an input variable points to a function which has another directional arrow that points to an output variable, the path between at least two of the input variable, the function, or the output variable represents an atomic operation. In addition, the search provider may use the shapes of the vertices (e.g., oval and rectangle) in order to determine which vertex represents a function and which vertex represents an input or output (or overlapping) variable. Other methods of distinguishing between types of vertices (e.g., input variables, output variables, or functions) may be used.

In another embodiment, the search provider may restrict the steps taken to obtain the results of the input-output search. Suppose that a content file is very large and has many paths between an input variable and an output variable. A user may wish to restrict a path (or find a shortest path). In addition to providing an input and/or output variable value in an interface to the search provider, the user may also include a maximum number of hops (or steps) which would limit the search provider to a maximum number of intermediate steps.

In an embodiment, it is possible that no match returns for an input-output search. FIG. 6D illustrates another example of an input-output search interface. Input-output search interface 600D, having a query box 602D, depicts a search query entered by a user employing a user device. The user enters “Preferences” as the input(s) variable and “Window” as the output variable. When the search provider parses the graph 500, no match returns and thus, no result is found between the provided input-output variable pair provided. Therefore, the input-output search interface 600D returns the results 604D providing a notification that no path exists or no results are found. The results 604D may include a help or more information icon to allow the user to perform a different search or provide further information regarding the notification.

By converting the content file into a tree and a graph, a user is able to search using input and/or output variables in a timely manner. Thus, input-output searching reduces time spent searching when compared to traditional, keyword searching techniques. Additionally, by using graphs to perform input-output searching, operational costs may be reduced as redundant code or data does not have to be rewritten. Complexity may also be reduced by eliminating redundant code. Moreover, these methods may heighten discoverability and increase user productivity as traditional searching methods may not yield precise results or it may take a user longer to sort through extraneous and unrelated results. Furthermore, allowing input-output searching by using graphs may save money, reduce computing resources needed to perform searching and dealing with software coding, and increase revenue.

When a user sends a search query to the search provider to perform input-output searching based on input and/or output variables, the search is focused specifically on input and output variable types. The graph facilitates the input-output searching for content files. This allows for a robust and targeted search as compared to a natural language keyword search.

The results of an input-output search provided by the search provider includes not only the path from the input variable to the output variable, but also provides a chain of path(s) as well as intermediate functions and overlapping variables connecting the input variable to the output variable.

In one embodiment, results of an input-output search may or may not be ranked. The search provider provides a finite and deterministic set of results (if any) which allows the user to find exactly the result sought.

In one example, suppose that a content file is edited and modified. The modifications may be minimal or drastic. In one embodiment, it may be possible to parse and index incrementally only the part of the content file that has changed and not the entire content file. The converter of the service provider may then convert only the changed part of the content file into a tree and graph (or modify the tree and/or graph accordingly) instead of creating a brand new tree and graph. The incremental indexing and conversion may reduce the need for resources as only an updated portion of the content file is reviewed by the converter.

In one embodiment, the converter can convert the content file into trees, and convert the trees into graphs, by using low-speed processors. Therefore, additional or special resources are not required in order to perform the conversion.

In one example, suppose there are ten content files, and the content is software code (e.g., represented by the software coding language C++). A system such as CMake may be used to execute certain elements only based on things that are changed. If for example, only one of the ten content files is modified, a build system may only instruct a compiler to recompile the one file that is changed. Thus, the trees and graphs can be generated completely from scratch by the search provider and graph generation system or an existing tree and/or graph can be updated by the compiler.

In one example, a converter may compare an existing (old) tree with a newly generated tree that is generated based on a change to the content file. The comparison may be referred to as “diff”. The converter may identify the vertices and/or edges that were added or removed. Based on the updates to the vertices and/or edges, the converter may add or remove vertices and/or edges in the graph, accordingly. The converter may be included within or external to the search provider and graph generation system. Any algorithms to perform “diff” may be used, including, for example, the Myers Difference Algorithm.

FIGS. 7A and 7B illustrate a method to convert a tree to a graph in order to facilitate input-output searching. The conversion of the tree to the graph may be performed in response to receiving an input-output search request sent by a user or the conversion may be performed any time (i.e., prior to receipt of the search request). In some embodiments, the conversion may be performed initially upon accessing a content file. The conversion (or a partial conversion that is performed when a portion of the content file changes) may also be performed periodically or based on a schedule.

Referring to FIG. 7A, a method 700 for improved input-output search includes receiving (702) a content file comprising a plurality of input variables, a plurality of functions, and a plurality of output variables. The content file can include content of interest to a searcher and, in some cases, contain a large amount of text where just a subset of that text is of interest to the searcher. The plurality of output variables and the plurality of input variables include overlapping variables. That is, outputs of some functions are inputs to other functions. To support the input-output search of the content file, method 700 includes converting (704) the content file into a tree; and then converting (706) the tree into a graph for an input-output search.

As mentioned above, the content file (e.g., the content file 122 or the content file 300 described above) may include multiple input variables, multiple functions and multiple output variables (as well as overlapping variables) that are not arranged in a format to facilitate input-output searching. The content file may be a source code content file or other type of textual and/or multimedia file or combination thereof. Such files can be converted into a tree of an abstract syntax tree.

FIG. 7B shows an example process of converting (706) the tree into a graph for an input-output search.

Processes 710 for converting (706) the tree into the graph can include traversing (712) the tree to identify each function in the tree. The tree is traversed to identify each function in the tree using any technique.

For each identified function, processes 710 include assigning (714) the identified function as a vertex of the graph; determining (716) any input variables and output variables associated with that function; and assigning (718) the determined input variables and output variables associated with that function as vertices of the graph connected to the vertex having the assigned identified function by directional edges.

As described above with respect to FIG. 5, the identified function is assigned as a vertex of the graph. For the function that is identified, any input and output variables that are associated with that function are determined. For example, suppose that the function “GetWindowByID” is identified. Vertex “GetWindowByID” 504 is assigned for that function. The input variable “int” and the output variable “Window” are determined. Finally, the input variable “int” and the output variable “Window” associated with the function “GetWindowByID” are assigned as vertices of the graph connected to the vertex “GetWindowByID” 504 having the assigned identified function by directional edges.

The directional edges may include respective directional arrows, as depicted in FIG. 5.

In one embodiment, the converting the tree into the graph further comprises determining that an overlapping variable comprises an input variable and an output variable. For example, it may be determined that the “Window” 506 in FIG. 5 is an overlapping variable as it is both an input variable and output variable.

In one embodiment, a pair of vertices and associated edges between the pair of vertices represents an individual atomic operation.

Once the graph is converted, it can be used to provide a result of an input-output search. Further details regarding providing this result are described with respect to FIG. 8.

FIG. 8 illustrates a method to provide a result of an input-output search. The request for the input-output search may be submitted by a user employing a user device and the user may provide at least one of an input variable or an output variable.

Referring to FIG. 8, a method including processes 800 can be performed to provide a result of an input-output search. Processes 800 can include storing (802) the graph in a structured data resource.

The graph 112 may be stored in the graph structured data resource 106, as depicted in FIG. 1.

Referring to FIG. 8, processes 800 include receiving (804) a request for the input-output search, the request comprising an input variable and an output variable.

The user requesting the search may provide an input variable and an output variable. In other embodiments, the user may instead provide either an input variable or an output variable or multiple input variables.

In one example, suppose that a user wishes to narrow down a search by adding overlapping variables or a set of functions. The search provider and graph generation system would interpret this search request as follows: “find the path from input(s) to output while going through all the overlapping variables,” and return a result. In another embodiment, the search provider and graph generation system would find all paths from the input(s) that lead to one of the outputs that is provided.

Referring again to FIG. 1, a request for the input-output search is received from the user device 102. The search provider and graph generation system 104 may receive the request. The request may be submitted via a user interface displayed on the user device 102.

Referring to FIG. 8, processes 800 include traversing (806) the graph to find the input variable and the output variable.

Referring to FIG. 5, the graph 500 is traversed by the search provider and graph generation system 104 to find the input variable and the output variable.

Referring again to FIG. 8, processes 800 include parsing (808) the graph to determine whether at least one path exists between the input variable and the output variable.

Referring again to FIG. 5, the graph 500 is parsed to determine whether a path exists between the input variable and the output variable. A path exists if one (or more) edges exist joining a vertex representing the input variable and a vertex representing the output variable. As shown in FIG. 5, the graph 500 includes vertices and edges. The graph 500 may be parsed using any method to determine if the path exists.

Referring to FIG. 8, in response to determining that the at least one path exists, processes 800 include providing (810) a result.

Referring again to FIG. 5, if at least one path is found, the result of the input-output search is provided to the user device 102. The result may be in a format similar to or the same as the examples provided in FIGS. 6A-6C. For example, the result may include the original input and output variables in the query, a number of results, a function, the input(s) variables, the output variables, and the number of steps taken to get from the input to the output variables.

In other embodiments, if no match exists, a notification may be sent to alert the user (as described in the example in FIG. 6D).

According to some embodiments, the search provider and graph generation system 104 may perform the method of FIG. 7A and the processes of FIG. 7B and FIG. 8. Additionally, the converter 114 may also perform some of the method of FIG. 7A and processes of FIG. 7B and FIG. 8.

In an embodiment, it may be determined that a second path exists between the input variable and the output variable. It may be further determined that a shorter path is one of the one path (from the parsing (808) process) or the second path.

In an embodiment, the result is provided in a format suitable for display by a graphical user interface of a device.

In an embodiment, the result is utilized by a search engine to optimize input-output search results in view of at least one of the input variable or the output variable. For example, a search engine may cache the result in case the same search query is repeated. In another example, the search engine may determine a shortest or best path (i.e., shortest hops) between the input and output variables and cache the result accordingly.

In an embodiment, the result is utilized to minimize redundant coding in a computer program.

In some embodiments, multiple content files may be used. In the example of multiple content files, the search provider and graph generation system would generate a graph for each content file individually, however, when parsing that graph and identifying input/output variables and functions, the search provider and graph generation system would append to a common graph (for all of the multiple content files).

In one example, incremental indexing is provided so that there is no need to run the workflow in FIG. 2 every time a user sends a search query. Instead, the search provider and graph generation system may run a workflow during initial setup or when any content file changes. Thus, when a user initiates an input/output search, the search provider may directly communicate with the index (or graph structured data resource 106).

FIG. 9 illustrates components of an example computing device that may be used in certain embodiments described herein. Referring to FIG. 9, system 900 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, or a smart television. Accordingly, more or fewer elements described with respect to system 900 may be incorporated to implement a particular computing device.

System 900 includes a processing system 905 of one or more processors to transform or manipulate data according to the instructions of software 910 stored on a storage system 915. Examples of processors of the processing system 905 include general purpose central processing units, application specific processors, and logic devices, as well as any other type of processing device, combinations, or variations thereof The processing system 905 may be, or is included in, a system-on-chip (SoC) along with one or more other components such as network connectivity components, sensors, video display components.

The software 910 can include an operating system 918 and instructions for various applications and programs, including instructions 920 for performing processes 700, 710, and 800 as described herein. Device operating systems 918 generally control and coordinate the functions of the various components in the computing device, providing an easier way for applications to connect with lower-level interfaces like the networking interface.

Storage system 915 may comprise any computer readable storage media readable by the processing system 905 and capable of storing software 910 including the instructions 920 and data (e.g., such as described with respect to content file structured data resource 120 and/or graph structured data resource 106).

Storage system 915 may include volatile and nonvolatile memories, removable and non-removable media implemented in any method or technology for storage of information, such as computer readable instructions, data structures, program modules, or other data. Examples of storage media of storage system 915 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal.

Storage system 915 may be implemented as a single storage device or may be implemented across multiple storage devices or sub-systems co-located or distributed relative to each other. Storage system 915 may include additional elements, such as a controller, capable of communicating with processing system 905.

Software 910 may be implemented in program instructions and among other functions may, when executed by system 900 in general or processing system 905 in particular, system 900 or the one or more processors of processing system 905 to operate as described herein.

The system can further include user interface system 930, which may include input-output (I/O) devices and components that enable communication between a user and the system 900. User interface system 930 can include input devices such as a mouse (not shown), track pad (not shown), keyboard (not shown), a touch device (not shown) for receiving a touch gesture from a user, a motion input device (not shown) for detecting non-touch gestures and other motions by a user, a microphone 935 for detecting speech, and other types of input devices and their associated processing elements capable of receiving user input.

The user interface system 930 may also include output devices such as display screen(s), speakers, haptic devices for tactile feedback, and other types of output devices. In certain cases, the input and output devices may be combined in a single device, such as a touchscreen, or touch-sensitive, display which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

Visual output may be depicted on the display (not shown) in myriad ways, presenting graphical user interface elements, text, images, video, notifications, virtual buttons, virtual keyboards, or any other type of information capable of being depicted in visual form.

The user interface system 930 may also include user interface software and associated software (e.g., for graphics chips and input devices) executed by the OS in support of the various user input and output devices. The associated software assists the OS in communicating user interface hardware events to application programs using defined mechanisms. The user interface system 930 including user interface software may support a graphical user interface, a natural user interface, or any other type of user interface. For example, the user interfaces described herein may be presented through user interface system 930.

Network/communications interface 940 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the operating system 918, which informs applications of communications events when necessary.

Certain techniques set forth herein with respect to the search provider and graph generation system 104 may be described in the general context of computer-executable instructions, such as program modules, executed by one or more computing devices. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Certain embodiments may be implemented as a computer process, a computing system, or as an article of manufacture, such as a computer program product or computer-readable storage medium. Certain methods and processes described herein can be embodied as software, code and/or data, which may be stored on one or more storage media. Certain embodiments of the invention contemplate the use of a machine in the form of a computer system within which a set of instructions, when executed by hardware of the computer system (e.g., a processor or processing system), can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory carrier waves or propagating signals.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
receiving a content file comprising a plurality of input variables, a plurality of functions, and a plurality of output variables, wherein the plurality of output variables and the plurality of input variables include overlapping variables;
converting the content file into a tree; and
converting the tree into a graph for an input-output search, wherein converting the tree into the graph comprises:
traversing the tree to identify each function in the tree;
for each identified function:
assigning the identified function as a vertex of the graph;
determining any input variables and output variables associated with that function; and
assigning the determined input variables and output variables associated with that function as vertices of the graph connected to the vertex having the assigned identified function by directional edges.

2. The method of claim 1, further comprising:
storing the graph in a structured data resource;
receiving a request for the input-output search, the request comprising an input variable and an output variable;
traversing the graph to find the input variable and the output variable;
parsing the graph to determine whether at least one path exists between the input variable and the output variable; and
in response to determining that the at least one path exists, providing a result.

3. The method of claim 2, further comprising determining that a second path exists between the input variable and the output variable and determining a shorter path being one of the at least one path or the second path.

4. The method of claim 2, further comprising providing the result in a format suitable for display by a graphical user interface of a device.

5. The method of claim 2, wherein the result is utilized by a search engine to optimize input-output search results in view of at least one of the input variable or the output variable.

6. The method of claim 2, wherein the result is utilized to minimize redundant coding in a computer program.

7. The method of claim 1, wherein the converting the tree into the graph further comprises determining that an overlapping variable comprises an input variable and an output variable.

8. The method of claim 1, wherein the directional edges comprise respective directional arrows.

9. The method of claim 1, wherein a pair of vertices and associated edges between the pair of vertices represents an individual atomic operation.

10. A search provider system, comprising:
a processing system;
a storage system; and
instructions stored at the storage system that when executed by the processing system, direct the processing system to at least:
receive a content file comprising a plurality of input variables, a plurality of functions, and a plurality of output variables, wherein the plurality of output variables and the plurality of input variables include overlapping variables;
convert the content file into a tree; and
convert the tree into a graph for an input-output search, wherein to convert the tree into the graph, the processing system is directed to at least:
traverse the tree to identify each function in the tree;
for each identified function:
assign the identified function as a vertex of the graph;
determine any input variables and output variables associated with that function; and
assign the determined input variables and output variables associated with that function as vertices of the graph connected to the vertex having the assigned identified function by directional edges.

11. The search provider system of claim 10, further comprising instructions stored at the storage system that when executed by the processing system, direct the search provider system to:
store the graph in a structured data resource;
receive a request for the input-output search, the request comprising an input variable and an output variable;
traverse the graph to find the input variable and the output variable;
parse the graph to determine whether at least one path exists between the input variable and the output variable; and
in response to a determination that the at least one path exists, provide a result.

12. The search provider system of claim 11, further comprising instructions stored at the storage system that when executed by the processing system, direct the search provider system to: determine that a second path exists between the input variable and the output variable and determining a shorter path being one of the at least one path or the second path.

13. The search provider system of claim 11, further comprising instructions stored at the storage system that when executed by the processing system, direct the search provider system to: provide the result in a format suitable for display by a graphical user interface of a device.

14. The search provider system of claim 13, wherein the graphical user interface further comprises the input variable and the output variable.

15. The search provider system of claim 11, wherein the result is utilized by a search engine to optimize input-output search results in view of at least one of the input variable or the output variable.

16. The search provider system of claim 11, wherein the result is utilized to minimize redundant coding in a computer program.

17. The search provider system of claim 10, wherein the instructions to convert the tree into the graph direct the search provider system to: determine that an overlapping variable comprises an input variable and an output variable.

18. The search provider system of claim 10, wherein the directional edges comprise respective directional arrows.

19. The search provider system of claim 10, wherein a pair of vertices and associated edges between the pair of vertices represents an individual atomic operation.

20. A computer readable storage medium having instructions stored thereon that, when executed by a computing system, direct the computing system to perform a method comprising:
receiving a content file comprising a plurality of input variables, a plurality of functions, and a plurality of output variables, wherein the plurality of output variables and the plurality of input variables include overlapping variables;
converting the content file into a tree; and
converting the tree into a graph for an input-output search, wherein converting the tree into the graph comprises:
traversing the tree to identify each function in the tree;
for each identified function:
assigning the identified function as a vertex of the graph;
determining any input variables and output variables associated with that function; and
assigning the determined input variables and output variables associated with that function as vertices of the graph connected to the vertex having the assigned identified function by directional edges.
